(19) United States
(12) Patent Application Publication
(10) Pub. No.: US 2011/0314791 A1
(43) Pub. Date: Dec. 29, 2011

(54) METHOD FOR COMBUSTION SYSTEM

(76) Inventors: Jeffrey D. Haynes, Stuart, FL (US); James T. Beals, West Hartford, CT (US); Paul Sheedy, Vernon, CT (US)

(21) Appl. No.: 12/823,701

(22) Filed: Jun. 25, 2010

(51) Int. Cl. F02K 9/00; B05D 1/36; B05D 1/12

(52) U.S. Cl. 60/253; 427/180; 427/201

(57) ABSTRACT

A method of fabricating a combustion system includes cold depositing a starting material onto a substrate as a solid metal fuel to produce a combustion structure.

### BACKGROUND

This disclosure relates to combustible, solid metal fuels for use in propulsion systems.

Conventional propulsion systems, such as those used for ramjet projectiles, aircraft or other vehicles, typically utilize liquid hydrocarbon fuel. However, hydrocarbon fuels have a relatively low energy density compared to other materials, such as metals. There have been attempts to use metal materials as fuels in propulsion systems. For instance, metal fuels have been combined with liquid hydrocarbon fuels to produce a fuel slurry or combined with organic binders and solid oxidizers to produce a fuel composite.

### SUMMARY

An example method of fabricating a combustion system includes cold depositing a starting material onto a substrate as a solid metal fuel to produce a combustion structure.

An example propulsion system disclosed herein includes a combustion chamber having an inlet, an exhaust, and a passage that extends between the inlet and the exhaust. A consumable lining extends along the passage of the combustion chamber. The consumable lining includes a solid metal fuel that is combustible to generate propulsion force.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example vehicle having a propulsion system and solid metal fuel.

FIG. 2 illustrates an example propulsion system having a combustion chamber and consumable lining

FIG. 3 illustrates the combustion chamber of FIG. 2 with the consumable lining depleted.

FIG. 4 illustrates another example consumable lining having a blended solid metal fuel.

FIG. 5 illustrates a multilayer consumable lining

FIG. 6 illustrates another example multilayer consumable lining.

FIG. 7 illustrates a consumable lining having geometric surface projections.

FIG. 8 illustrates another example consumable lining having geometric surface projections and an additional level of surface roughness or interconnected void space.

FIG. 9 illustrates an example combustion chamber having a consumable lining that includes an ignition material.

FIG. 10 illustrates another example consumable lining having a composition that varies along the liner between the inlet and exhaust of the combustion chamber.

### DETAILED DESCRIPTION OF THE PREFERRED EMBODIMENT

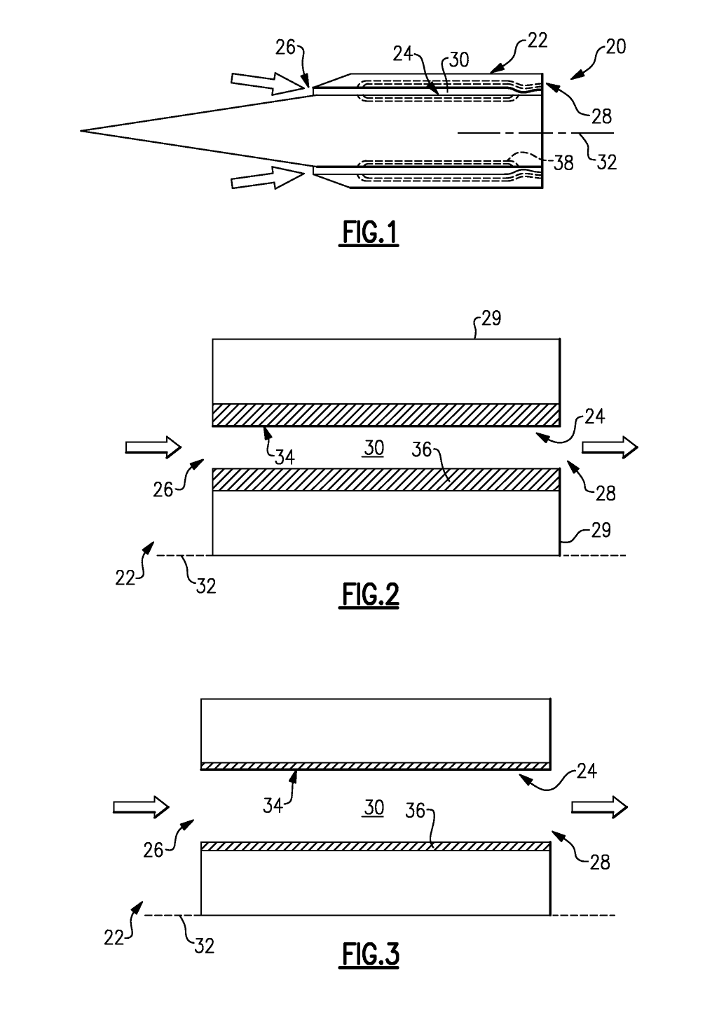

FIG. 1 illustrates selected portions of an example vehicle 20 that includes a propulsion system 22 for moving the vehicle 20. For instance, the vehicle 20 may be a ramjet, such as in a powered projectile, aircraft, or other type of vehicle.

As also illustrated schematically in FIG. 2, the propulsion system 22 includes a combustion chamber 24. The combustion chamber 24 includes an inlet 26, an exhaust 28, and a passage 30 that extends between the inlet 26 and the exhaust 28, and walls 29. The walls 29 may be a casing, a penetrator of a ramjet projectile, or other structure of the vehicle 20. In this example, the combustion chamber 24 extends annularly around a center line 32 of the vehicle 20. However, the combustion chamber 24 is not limited to an annular design and may be configured differently, depending upon the design of the vehicle 20.

A consumable lining 34 extends along the passage 30 of the combustion chamber 24. The consumable lining 34 includes a combustible, solid metal fuel 36 that may be selectively burned during operation of the vehicle 20 to propel the vehicle 20 forward.

As illustrated in FIG. 3 and as indicated by the dashed lines 38 in FIG. 1, the consumable lining 34 depletes as the solid metal fuel 36 burns. That is, air enters the inlet 26 of the vehicle 20 and facilitates burning of the solid metal fuel 36. The air, potentially some burnt or spent solid metal fuel 36, and other combustion products may exit the vehicle through the exhaust 28.

The solid metal fuel 36 provides the benefit of a much greater energy density than conventional hydrocarbon fuels, hydrocarbon slurries, or hydrocarbon composites. Depending on the composition, architecture, combustion kinetics, heat transfer, and oxide formation of the burning metal, the use of the solid metal fuel 36 has the potential to achieve a significant improvement in speed, range, and payload of the vehicle 20 compared to using hydrocarbon fuels.

In general, metals may burn in two different modes, depending on the properties of the metal oxide compared to the metal itself. One mode is vapor phase combustion, in which metal vapor driven off of the molten metal surface mixes with oxidizer above the metal surface and reacts to form a diffusion flame. The other mode is surface combustion where the oxidation reactions occur on the metal surface. Thus, the composition and architecture of the consumable lining 34 may be controlled to achieve a particular desired mode of burning to facilitate sustained combustion in the propulsion system 22.

The solid metal fuel 36 of the consumable lining 34 (e.g., combustion structure) may be fabricated by cold depositing a starting material onto a substrate as a solid metal fuel to produce the combustion structure with a high-combustibility. That is, the starting materials are deposited in a composition or architecture that renders the solid metal fuel of the consumable lining 34 sustainably combustible. For example, the starting material is cold deposited from at least one kind of powder material using cold spraying, also known as cold gas dynamic spraying, to achieve a composition, architecture, or combination thereof having high combustibility. Cold spraying provides the ability to control the deposition to achieve a composition and/or architecture that is suitable for sustainable combustion.

The cold spray process may utilize compressed nitrogen or helium gas to carry powder particles through a specially designed nozzle that accelerates the powder to a speed on the order of Mach 3. The powder may be heated slightly as a result of coming into contact with the compressed, hot carrier gas. However, the resonant time in the gas prior to rapid expansion and cooling of the gas is short and the powder does not significantly increase in temperature. That is, deposition of the powder relies substantially on kinetic energy, rather than high temperature melting or partial melting, to plastically deform and consolidate the powder onto a suitable substrate. The gas temperature, pressure, and particle size may be controlled to adjust the porosity of the deposited structure. One benefit of utilizing the cold spray process is that the materials being deposited are not heated and therefore do not melt, oxidize or anneal as part of the deposition process. Moreover, materials having different characteristics can be co-deposited without interacting, such as a metal and a non-metal (e.g., a polymeric material as an igniter material) or a metal and another different metal. Also, cold spray can be used to deposit or control the density of the consumable lining, and the cohesive and adhesive strengths between the deposited particles. For instance, the combustion structure can be formed with less than 5 vol % porosity, and in some examples may be formed with a nominal porosity close to 0 vol %. The following examples illustrate compositions and/or architectures that may be achieved by cold spraying at least one kind of powder as the starting material.

The solid metal fuel 36 of the consumable lining 34 may be made substantially of or include a combustible, high-energy density metal, such as beryllium, boron, magnesium, aluminum, silicon, scandium, titanium, vanadium, chromium, manganese, iron, yttrium, zirconium, molybdenum, lanthanum, hafnium, and tungsten. As will be described in further detail, the consumable lining 34 may include one or more of the metals listed above as the solid metal fuel 36. Generally, some of these metals may be more attractive for use as the solid metal fuel 36 because of higher energy density and ability to sustain combustion.

In some examples, the consumable lining 34 may have a single or multiphase composition of the above-listed metals, or include a multilayered structure of single and/or multiphase layers. For instance, cold spraying allows the consumable lining 34 to be formed from metal grains or metal particles that are weakly adhered together such that the grains or particles break-off or are released into the passage 30 during operation of the vehicle 20, to sustain combustion. The carrier gas temperature, pressure and particles size may be selected to achieve a suitable bonding force between the metal grains.

Additionally, the consumable lining 34 may include ignition materials to control combustion of the solid metal fuel 36 or to enable self-sustained combustion in low-oxygen environments, such as under water. In further examples, the solid metal fuel 36 may also serve as a structural, load-bearing member in the combustion chamber 24. That is, the solid metal fuel 36 may be formed with features or geometry that facilitate supporting other structures in the vehicle 20, unlike liquid or hydrocarbon fuels.

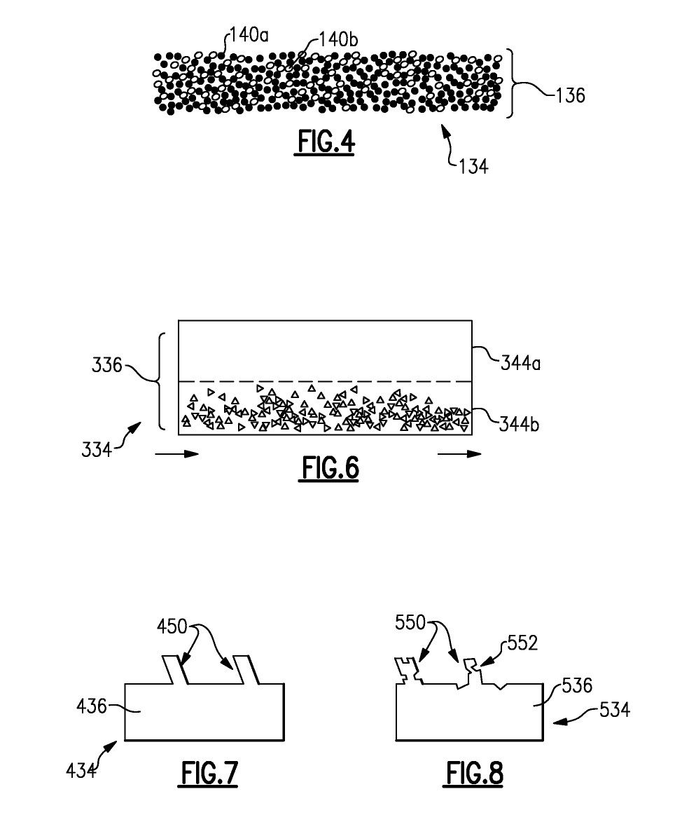

FIG. 4 illustrates an example of a portion of a consumable lining 134 and solid metal fuel 136 that may be used in the vehicle 20. In this disclosure, like reference numerals designate like elements where appropriate, and reference numerals with the addition of one-hundred or multiples thereof designate modified elements that are understood to incorporate the same features and benefits of the corresponding original elements. In this example, the solid metal fuel 136 has a multiphase composition that includes at least a first constituent 40a and a second constituent 40b that is blended with the first constituent 40a. In this case, the solid metal fuel 136 is a uniform blend of the first constituent 40a and the second constituent 40b. Alternatively, the concentrations of the first constituent 40a and the second constituent 40b may vary through the consumable lining 134.

The constituents may be selected from beryllium, boron, magnesium, aluminum, silicon, scandium, titanium, vanadium, chromium, manganese, iron, yttrium, zirconium, molybdenum, lanthanum, hafnium, tungsten, and a thermite material, e.g. a metal/oxidizer composition. In one particular example, the first constituent 40a is aluminum and the second constituent 40b is boron. In another example, the first constituent 40a is titanium and the second constituent 40b is silicon. In other examples, one of the constituents 40a or 40b may serve as an ignition material, such as magnesium or a thermite material. The ignition material may be blended with one or more metals of the solid metal fuel 136 and serve to sustain or initiate burning of the solid metal fuel 136. The technique of cold spraying allows multiple kinds of powders to be deposited in a composition and structure that is desired for sustainable combustion.

FIG. 5 illustrates another example consumable lining 234 and solid metal fuel 236 that may be used in the vehicle 20. In this case, the consumable lining 234 is deposited as a multilayered structure that includes a first layer 244a and a second layer 244b that adjoins the first layer 244a. Although only two layers are shown, it is to be understood that additional layers that include the above given example materials may alternatively be included. The layers 244a and 244b may be single or multiphase as described above. Alternatively, one of the layers 244a or 244b may be an ignition material as described above for igniting and sustaining combustion of the other layer 244a or 244b.

FIG. 6 illustrates another example portion of a consumable lining 334 and solid metal fuel 336. In this example, the consumable lining 334 is also multilayer structure and includes a first layer 344a and a second layer 344b that adjoins the first layer 344a. The first layer 344a is single and the second layer 344b is multiphase. For instance, the first layer 344a may be titanium and the second layer 344b may be a composite of titanium and silicon.

In operation, the titanium and silicon of the second layer 344b react to form titanium silicide. The reaction results in open porosity in the second layer 344b, which allows gaseous oxidant, such as air, to move to the first layer 344a. Upon achieving a threshold level of porosity in the second layer 344b, the metal of the first layer 344a may ignite. Thus, the second layer 344b provides the benefit of controlling ignition and combustion of the first layer 344a.

FIG. 7 illustrates another example of a portion of a consumable lining 434, which can be single or multiphase, or be multilayered as described above. In this example, the consumable lining 434 includes geometric surface projections 450 that extend from the surface of the consumable lining 434 into the passage 30. As an example, the geometric surface projections 450 may be macro-features having dimensions on the order of a millimeter or more. Alternatively, the geometric surface projections 450 may be micro-sized or even nano-sized, to increase surface area and facilitate sustaining combustion. Additionally, the geometric surface projections 450 may facilitate the release of portions of the consumable lining 434 into the passage 30 for combustion.

FIG. 8 illustrates another example consumable lining 534 that is somewhat similar to the consumable lining 434 of FIG. 7. In this case, the consumable lining 534 also includes geometric surface projections 550. However, the exposed surface of the consumable lining 534 also includes an additional level of surface roughness/texture or interconnected voids 552 that further increase the exposed surface area for burning. The interconnected voids 552 may be formed during fabrication of the consumable lining 534. For instance, the starting material powders used in the cold spraying process may include a sacrificial or fugitive material along with a metal. The powders are co-deposited and the fugitive material is then removed, such as by acid or caustic solution leaching or low temperature volatilization of the fugitive material to create the interconnected voids 552.

FIG. 9 illustrates another example consumable lining 634 for use in the combustion chamber 24. In this example, the consumable lining 634 includes an ignition material 660 near or at the inlet 26. The ignition material 660 may selectively be ignited to initiate burning of the solid metal fuel 36 (or solid metal fuel 136, 236, 336, 436, or 536). In some examples, the ignition material 660 may include magnesium, a thermite material, or a composite that includes an oxidizer such as a fluorine-containing material. For instance, the composite may be a mixture of magnesium metal and the fluorine-containing material. The fluorine-containing material may be polytetrafluoroethylene, a fluoroelastomer, or a combination thereof. In one particular example, the composite includes 30-65 mole % of the magnesium and a remainder of the fluorine-containing material. Cold spraying allows the dissimilar, yet reactive materials of magnesium and the fluorine-containing material to be co-deposited to form the consumable lining 634 without undergoing significant chemical changes.

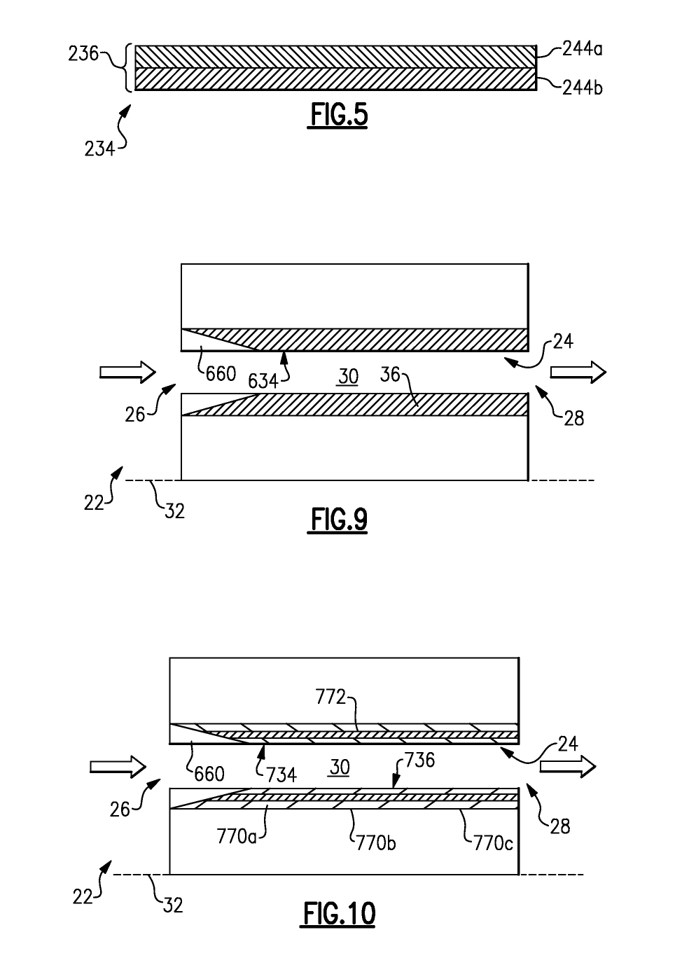

FIG. 10 illustrates another example consumable lining 734 that may be used in the combustion chamber 24. In this case, the composition of the solid metal fuel 736 varies along the liner between the inlet 26 and the exhaust 28. For example, the solid metal fuel 736 of the consumable lining 734 includes a first region 770a that is located near the ignition material 660, a second region 770b that is located downstream from the first region 770a (relative to flow from the inlet 26 to the exhaust 28), and a third region 770c that is located downstream from the second region 770b. Although three regions 770a-c are shown in this example, it is to be understood that fewer or additional regions may be used, depending upon the particular design of the vehicle 20 and combustion chamber 24.

The regions 770a-c each have a different composition. For instance, the compositions of the regions 770a-c may be single phase, multiphase, multilayered, or have any of the structures or compositions disclosed herein. Cold spraying may be used to fabricate such an architecture and composition by using different kinds of powders as the starting material to form the different regions 77-a-c. Additionally, the ignition material 660 may extend through the solid metal fuel 736. As an example, a layer 772 may extend through the solid metal fuel 736 to facilitate sustaining combustion of the solid metal fuel 736 and opening a passageway for exposure of the solid metal fuel composition to oxidant gas from the passage 30 of the combustion chamber 24. As an example, the ignition material of the layer 772 may be the same as or different than the ignition material 660. In one example, the ignition material of the layer 772 is a thermite material.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method of fabricating a combustion system, the method comprising:
cold depositing a starting material onto a substrate as a solid metal fuel to produce a combustion structure.

2. The method as recited in claim 1, wherein the cold depositing comprises cold spraying at least one kind of powder as the starting material.

3. The method as recited in claim 1, wherein the cold depositing comprises cold spraying at least one kind of powder as the starting material to form the combustion structure with less than 5 vol % porosity.

4. The method as recited in claim 1, wherein the cold depositing comprises cold spraying multiple kinds of powders to form the solid metal fuel.

5. The method as recited in claim 2, wherein the cold depositing comprises cold spraying a metal and a fluorine-containing material.

6. The method as recited in claim 2, wherein the at least one kind of powder is single phase and is selected from a group consisting of beryllium, boron, magnesium, aluminum, silicon, scandium, titanium, vanadium, chromium, manganese, iron, yttrium, zirconium, molybdenum, lanthanum, hafnium, and tungsten.

7. The method as recited in claim 2, wherein the at least one kind of powder is single phase and is selected from a group consisting of boron, aluminum, titanium, chromium, and tungsten.

8. The method as recited in claim 2, wherein the at least one kind of powder is multiphase and includes elements selected from a group consisting of beryllium, boron, magnesium, aluminum, silicon, scandium, titanium, vanadium, chromium, manganese, iron, yttrium, zirconium, molybdenum, lanthanum, hafnium, and tungsten.

9. The method as recited in claim 2, wherein the at least one kind of powder is multiphase and includes titanium and silicon.

10. The method as recited in claim 2, wherein the at least one kind of powder is multiphase and includes elements selected from a group consisting of boron, aluminum, titanium, chromium, and tungsten.

11. The method as recited in claim 2, wherein the at least one kind of powder is multiphase and includes aluminum and boron.

12. The method as recited in claim 2, wherein the at least one kind of powder includes a thermite material and a metal.

13. The method as recited in claim 1, including forming the combustion structure with an architecture that is sustainably combustible.

14. The method as recited in claim 13, including forming geometric surface protrusions on the combustion structure.

15. The method as recited in claim 13, including forming the combustion structure with a fugitive material and then removing the fugitive material to form voids in the combustion structure.

16. The method as recited in claim 13, including depositing, as the combustion structure, a first layer having a first solid metal fuel composition and a second layer having a second, different solid metal fuel composition.

17. The method as recited in claim 1, including depositing the combustion structure to have a composition that varies along a dimension of the combustion structure.

18. A propulsion system comprising:
a combustion chamber that includes an inlet, an exhaust, and a passage extending between the inlet and the exhaust; and
a consumable lining that extends along the passage of the combustion chamber, the consumable lining comprising a combustible, solid metal fuel.

19. The propulsion system as recited in claim 18, wherein the solid metal fuel is single phase and is selected from a group consisting of beryllium, boron, magnesium, aluminum, silicon, scandium, titanium, vanadium, chromium, manganese, iron, yttrium, zirconium, molybdenum, lanthanum, hafnium, and tungsten.

20. The propulsion system as recited in claim 18, wherein the solid metal fuel is multiphase and includes elements selected from a group consisting of beryllium, boron, magnesium, aluminum, silicon, scandium, titanium, vanadium, chromium, manganese, iron, yttrium, zirconium, molybdenum, lanthanum, hafnium, and tungsten.

21. The propulsion system as recited in claim 20, wherein the consumable lining additionally includes a thermite material.

22. The propulsion system as recited in claim 18, wherein the consumable lining includes a first layer having a first solid metal fuel composition and a second layer having a second, different solid metal fuel composition.

23. The propulsion system as recited in claim 22, wherein the first composition is multiphase and the second composition is single phase.

24. The propulsion system as recited in claim 18, wherein the consumable lining is a composite of a metal and a fluorine-containing material.

25. The propulsion system as recited in claim 18, wherein the composition of the solid metal fuel varies along a dimension of the consumable lining.

26. The propulsion system as recited in claim 18, wherein the consumable lining includes geometric surface protrusions.

27. The propulsion system as recited in claim 18, wherein the consumable lining includes interconnected void space.

28. A vehicle comprising:
a propulsion system having a combustion chamber that includes an inlet, an exhaust, and a passage extending between the inlet and the exhaust, and a consumable lining that extends along the passage of the combustion chamber, the consumable lining comprising a combustible, solid metal fuel.
